(19) United States
(12) Patent Application Publication
(10) Pub. No.: US 2006/0176516 A1
(43) Pub. Date: Aug. 10, 2006

(54) System and method for embedding and retrieving information in digital images and using the information to copyright the digital images

(75) Inventor: Leigh M. Rothschild, Plantation, FL (US)

Correspondence Address: CASELLA & HESPOS, 274 MADISON AVENUE, NEW YORK, NY, 10016, US

(73) Assignee: Rothschild Trust Holdings, LLC, Sunny Isles Beach, FL (US)

(21) Appl. No.: 11/394,820

(22) Filed: Mar. 31, 2006

Related U.S. Application Data
(63) Continuation-in-part of application No. 11/020,459, filed on Dec. 22, 2004.
Application No. 11/020,459 is a continuation-in-part of application No. 10/998,691, filed on Nov. 29, 2004.

(51) Int. Cl. G06F 3/12

(52) U.S. Cl. 358/1.15; 358/3.28

(57) ABSTRACT

A system and method for embedding information in digital images and using the information to copyright the digital images are provided. The system includes a digital imaging capture device including a capture module configured to capture at least one digital image; a processing module configured to associate information to the digital image; and a transmission module configured to transmit the digital image and the associated information to a computing device; and the computing device including a communication device configured to receive at least one digital image file and associated information; and a processor configured to parse the associated information and store each piece of parsed information in at least one field of a record of a database, populate at least one field of a copyright registration form with information extracted from the database, and transmit the copyright registration form to a copyright office of a particular jurisdiction.

### CROSS REFERENCE TO RELATED APPLICATIONS

The present application is a continuation-in-part application of U.S. application Ser. No. 11/020,459, filed Dec. 22, 2004 entitled “SYSTEM AND METHOD FOR EMBEDDING AND RETRIEVING INFORMATION IN DIGITAL IMAGES”, which is a continuation-in-part application of U.S. application Ser. No. 10/998,691, filed Nov. 29, 2004 entitled “DEVICE AND METHOD FOR EMBEDDING AND RETRIEVING INFORMATION IN DIGITAL IMAGES”, the contents of both of which are hereby incorporated by reference.

### BACKGROUND

1. Field

The present disclosure relates generally to digital image processing, and more particularly, to systems and methods for embedding and retrieving information in digital images and using the information to organize, process and control the digital images. The present disclosure also relates to systems and methods for using the embedded information to automatically copyright the digital images and to apply for copyright registration in a jurisdiction's applicable copyright office e.g., the Unites States Copyright Office.

2. Description of the Related Art

Photographs are taken for a variety of personal and business reasons. During the course of a year, an individual may take numerous photographs of various events. During these events, quite often there are a variety of different individuals and items present in these photographs. In the prior art, when one desires to catalog these images in a particular order, they usually are left to placing these images manually into photograph albums. This is a very extensive, manual procedure requiring a significant amount of time. In addition, it is very limited with regard to the amount of information that can be associated with the image in a quick and easy manner. While some photo albums allow the writing and placing of text, the entering of this data is a very time consuming and arduous affair. Once having sorted these images into particular albums which may represent categories of interest, it is extremely difficult to retrieve and/or reorganize the images into other categories.

With the advent of digital cameras and digital imaging, the process of organizing images and associating information with the images has become even more difficult. Firstly, upon capturing an image with a digital camera, the camera simply gives the image a numerical file name which usually has no meaning to the user and makes it difficult to retrieve the image at a later date. Secondly, with the technological advances in file size compression and increased capacity of storage media, several hundred images may be taken before a user downloads the images to a computer or other device, making it a very time consuming task to associate information to each image.

In a related field, photographers may desire to obtain copyright protection for the images they capture to prevent the unauthorized use of these images or photographs. Although under current U.S. Copyright laws a “work”, e.g., a photograph, is automatically protected by copyright when it is created, i.e., when it is fixed in a copy, the copyright law provides several inducements or advantages to encourage copyright owners to make a federal registration. Among these advantages are the following: registration establishes a public record of the copyright claim; before an infringement suit may be filed in court, registration is necessary for works of U.S. origin; if made before or within 5 years of publication, registration will establish prima facie evidence in court of the validity of the copyright and of the facts stated in the certificate; if registration is made within 3 months after publication of the work or prior to an infringement of the work, statutory damages and attorney's fees will be available to the copyright owner in court actions, otherwise, only an award of actual damages and profits is available to the copyright owner; and registration allows the owner of the copyright to record the registration with the U.S. Customs Service for protection against the importation of infringing copies. However, due to the volume of images a photographer may capture in a short period of time, applying for copyright registration can be an arduous and labor intensive task.

Therefore, a need exists for techniques for easily associating information about an image to the image and using the information to control and retrieve the image. Furthermore, a need exits for techniques for using the associated information to automatically copyright the images and to apply for copyright registration in a jurisdiction's applicable copyright office e.g., the United States Copyright Office.

### SUMMARY

Devices, systems and methods for capturing, storing, allowing user input, receiving internal input, processing, transmitting, scanning, and displaying digital images are provided. Digital photography has gained a substantial share of the worldwide photographic market. More and more cameras record images in digital form and more and more of these images are stored digitally for retrieval or archival purposes on home and business computers and on the Global Computer Network, e.g., the Internet. The present disclosure describes hardware devices, systems and methods that will facilitate embedding information into digital images of any type (e.g., jpeg, bmp, tiff, etc.) to organize, control and manipulate these images both while in digital form, and later when in printed form. The present disclosure further provides a system and method of imbedding and retrieving information in digital images and using this information and the Global Computer Network, e.g., the Internet to automatically copyright these digital images with a particular jurisdiction's applicable copyright office, e.g., the Unites States Copyright Office.

According to one aspect of the present disclosure, a method for applying for copyright registration for at least one digital image is provided. The method includes the steps receiving at least one digital image file along with information associated to the at least one digital image; parsing the associated information and storing each piece of parsed information in at least one field of a record of a database; populating at least one field of a copyright registration form with information extracted from the database; and transmitting the copyright registration form to a copyright office of a particular jurisdiction. The associated information includes at least one of a title of the at least one digital image, name and address of author of the at least one digital image, year of creation of the at least one digital image, the date and nation of publication of the at least one digital image and type of authorship.

In another aspect, the method further includes the step transmitting the at least one digital image file to the copyright office.

According to a further aspect of the present disclosure, a system for applying for copyright registration for at least one digital image is provided. The system includes a digital imaging capture device including: a capture module configured to capture at least one digital image; a processing module configured to associate information to the at least one digital image; and a transmission module configured to transmit the at least one digital image and the associated information to a computing device; and the computing device includes: a communication device configured to receive at least one digital image file and associated information; and a processor configured to parse the associated information and store each piece of parsed information in at least one field of a record of a database, populate at least one field of a copyright registration form with information extracted from the database, and transmit the copyright registration form to a copyright office of a particular jurisdiction through the communication device.

In another aspect, a program storage device readable by a machine, tangibly embodying a program of instructions executable by the machine to perform method steps for applying for copyright registration for at least one digital image is provided, the method steps including receiving at least one digital image file along with information associated to the at least one digital image; parsing the associated information and storing each piece of parsed information in at least one field of a record of a database; populating at least one field of a copyright registration form with information extracted from the database; and transmitting the copyright registration form to a copyright office of a particular jurisdiction.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1A is front view of a device for capturing digital images and embedding information in the captured images according to an embodiment of the present disclosure;

FIG. 1B is a rear view of the device illustrated in FIG. 1A;

FIG. 2 is a block diagram of various modules included in a device for capturing images and embedding information in the images in accordance with the present disclosure;

FIG. 3A is front view of a device for capturing digital images and embedding information in the captured images according to another embodiment of the present disclosure;

FIG. 3B is a rear view of the device illustrated in FIG. 3A;

FIG. 4 is a flowchart illustrating a method for embedding information in a digital image according to an embodiment of the present disclosure;

FIG. 5 is a diagram of an exemplary system for managing a plurality of digital images in accordance with an embodiment of the present disclosure;

FIG. 6A is a flowchart illustrating a method for receiving at least one image with its associated information and processing requests associated with the at least one image;

FIG. 6B is a flowchart illustrating a method for retrieving an image and processing user requests;

FIG. 7 is a diagram of at least three records of a relational database employed in accordance with the present disclosure;

FIG. 8 is a flowchart illustrating a method for automatically applying for a copyright registration for a captured digital image in accordance with the present disclosure; and

FIG. 9 is a Short Form VA of the United States Copyright Office which has been completed with information in accordance with an embodiment of the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail. Throughout the figures like reference numerals represent like elements.

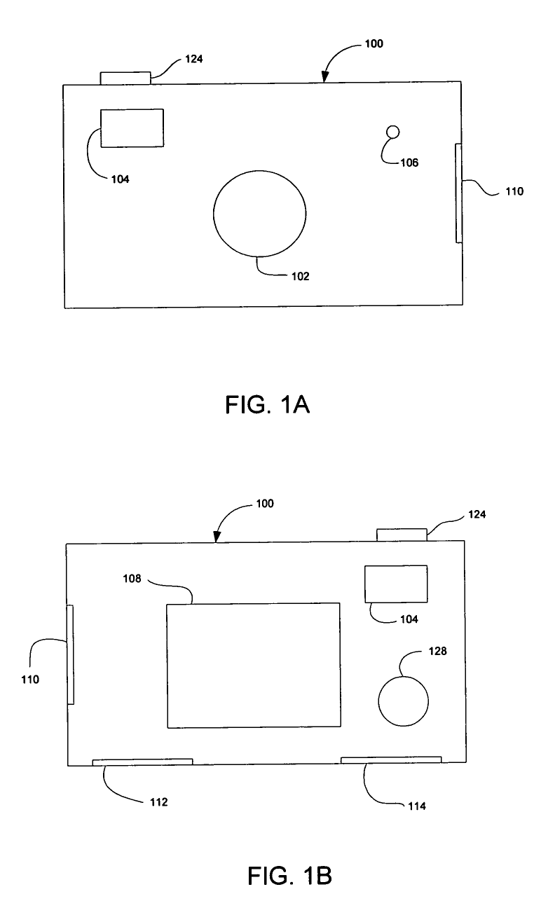

Hardware devices, systems and methods thereof that will enable the embedding and retrieving of information in digital images are provided. The embedded information will enable a user to organize, process and control these images. Referring to FIGS. 1A and 1B, a device 100 for capturing images and associating information about the captured images is shown. The device 100 includes a lens 102 coupled to a capture module, which will be described in detail below, for capturing an image and a viewfinder 104 for correctly positioning the device when capturing an image. The device 100 further includes a microphone 106 for acquiring audio, from the user of the device or from the subject of the image, which may be associated with the image.

A rear side of the device 100 is illustrated in FIG. 1B where a display module 108 is provided for displaying the captured image. As will be described in more detail below, the display module 108 may include a touch screen for facilitating user input of information to be associated with a digital image. The device 100 further includes a storage module 110 for storing a plurality of images, a transmission module 112 for transmitting the plurality of images to another device, e.g., a personal computer, a personal digital assistant (PDA), a server residing on the Internet, etc., and a scanning module 114 for scanning and inputting information to be associated with an image and for reading information from printed images.

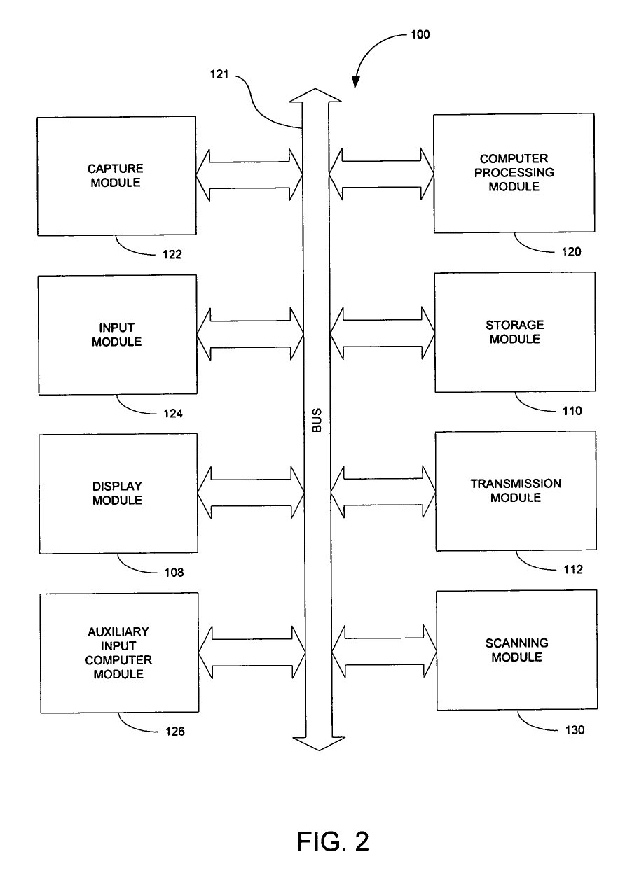

Referring to FIG. 2, the various components of the device 100 will now be described. The device will contain a computer processing module 120, e.g., a microprocessor. The computer processing module 120 will use computer software instructions that have been programmed into the module and conventional computer processing power to interact and organize the traffic flow between the various other modules. It is to be understood that the present disclosure may be implemented in various forms of hardware, software, firmware, special purpose processors, or a combination thereof. A system bus 121 couples the various components shown in FIG. 2 and may be any of several types of bus structures including a memory bus or memory controller, a peripheral bus, and a local bus using any of a variety of bus architectures. The device also includes an operating system and micro instruction code preferably residing in read only memory (ROM). The various processes and functions described herein may either be part of the micro instruction code or part of an application program (or a combination thereof) which is executed via the operating system.

It is to be further understood that because some of the constituent device components and method steps depicted in the accompanying figures may be implemented in software, the actual connections between the device components (or the method steps) may differ depending upon the manner in which the present disclosure is programmed. Given the teachings of the present disclosure provided herein, one of ordinary skill in the related art will be able to contemplate these and similar implementations or configurations of the present disclosure.

Capture module 122 will capture an image desired by the user in digital form. The capture module includes an image sensor, an analog-to-digital (A/D) converter and a digital signal processor (DSP). As the user pushes the device's shutter button 124, light is allowed to enter through the lens 102 and shine on the image sensor, e.g., a charge-coupled device (CCD) or complimentary metal-oxide semiconductor (CMOS). The image sensor includes preferably millions of photosensors, e.g., pixels, wherein each pixel absorbs the light and transforms the light into an electric charge proportional to the intensity of light. Each charge is transmitted to an A/D converter where the charge is converted into a digital value representing the color the pixel will be, e.g., representing different intensities of red, green and blue. The digital values are then passed to the digital signal processor which enhances the image, compresses it and then stores it in a digital file format in the storage module 110. The storage module 110 includes internal storage memory, e.g., random access memory (RAM), or removable memory such as a CompactFlash card, Memory Stick, SmartMedia, MultiMediaCard (MMC), SD (Secure Digital) memory, or any other memory storage that exists currently or will exist in the future. The digital file format utilized to store the image is not critical, but may include standard file formats which currently exist or will exist in the future for example jpeg, tiff, bmp, gif, pcx, png or other file formats. If multiple images are captured, the images may be stored in various video formats which currently exist including Divx, Mpeg-2, Mpeg-3, Mpeg-4, Mpeg-5, Quicktime, or other video formats.

The device 100 will also contain a display module 108 for the user to view acquired images. This display may be in any current form in the art, including Liquid Crystal Displays (LCD), Light emitting diode displays (LED), Cathode Ray Tube Displays (CRT) or any other type of display currently existing or existing in the future. The display module 108 will also include an audio output device 128, e.g., a speaker, headphone jack, etc., allowing the user to also hear audio output from the hardware device. An additional but optional embodiment of the present disclosure may also include video or computer output jacks that will allow the user to hook the subject hardware device to an external television display device or a computer.

The hardware device 100 of the present disclosure will contain a user input module 124 to either receive user instructions via text input by the way of a standard keyboard interface or a character recognition capture device which translates user text input into alphanumeric characters. Preferably, the character recognition device is a touch screen which overlays the display module 108 and text is entered via a pen-like stylus. Such input devices are standard and currently available on many electronic devices including portable digital assistants (PDAs) and cellular telephones. Optionally, a microphone 106 will be coupled to the input module 124 for capturing any audio information spoken by the user and the input module will further include an analog-to-digital (A/D) converter for converting the spoken audio information into digital format. Furthermore, the input module may include a voice recognition processor that translates the digital human voice into alphanumeric characters for user input.

The user will utilize the user input module after an image is captured to enter various data that will either be stored as a file associated with the digital image file or, alternatively, written as an additional part of the digital image file. By example, if the digital image is recorded by the hardware device as jpg101 or tif101 or bmp101 where these descriptions indicate the name of the captured digital image, then another file will be created for each captured digital image. This file would be the information associated file. In the above example, the image jpg101 would now have an additional file called info101 (or any other name that the hardware device selects). This digital file would receive and contain the user inputted information. Alternatively, the user input module may write its information directly to the previously stored digital image file. By example, if the digital image is recorded by the hardware device as jpg101 or tif101 or bmp101 where these descriptions indicate the name of the captured digital image, then this file will be appended with the additional information written from the user input module, for example, in the header of the digital image file.

The device 100 will also include an auxiliary input computer module 126. This module will allow the hardware device to automatically and simultaneously (with image capture) store information in the associated file or alternatively in the same file as the digital image. The information from the auxiliary input module 126 will flow directly from the various input modules and processors contained in the hardware device. These modules and processors may include but are not limited to a processor to determine the individual number of the picture in the sequence of pictures shot that are captured and stored, e.g., a sequence number, a Global Positioning System (GPS) chip to determine the geographic location of where the image was taken, a date chip to determine the date and time the image was taken, a voice capture device to capture comments on the image, and various other input processors that will provide additional information relevant to the digital information, all information which the auxiliary input module 126 will store as information in the info files or directly as addenda in the digital image files. Knowledge of the art, indicates that the individual processors such as GPS, date/time and voice storage, may be separate processors or may also be incorporated as one computer processor.

After the digital image is captured and stored on the device 100, these files will be transferred to the user's local computer hardware device or to the Global Computer Network, e.g., the Internet, or to the user's local device and then to the Global Computer Network. This transfer will be done by transmission module 112 including hardwired and/or wireless connectivity. The hardwire connection may include but is not limited to hard wire cabling e.g., parallel or serial cables, USB cable, Firewire (1394 connectivity) cables, and the appropriate port. The wireless connection will operate under any of the various known wireless protocols including but not limited to Bluetooth™ interconnectivity, infrared connectivity, radio transmission connectivity including computer digital signal broadcasting and reception commonly referred to as Wi-Fi or 80211.X (where x denotes the type of transmission), or any other type of communication protocols or systems currently existing or to be developed for wirelessly transmitting data. Furthermore, the transmission module 112 may include a removable memory card slot for accepting any of the various known removable memory cards, transferring the image files to the removable card, and subsequently the images may be uploaded to a computer from the removable memory card by an appropriate reader coupled to the user's computer. The file name of each digital image file and/or associated file will be recorded in a relational database either on the user's local computer or the Global computer network, as will be described in detail below. This database will contain information on any file(s) related to each digital image including audio and video files, or other associated image files.

The user, or any other party, may print out any of the digital images described herein. The printing will be done once the images are stored on the local computer or the Global Computer Network and recorded in a relational database as described above. When the images are printed out, the computer that prints the image will cause the image to be printed with symbology that encodes that file name of the image and file location of the image, or any other coding that will provide access to the file name and file location. This file name may be the assigned name that the image was stored in at the relational database, as well as the assigned location of the relational database whether in the user's local computer or at a stored location on the Global Computer Network. The symbology may be in any form currently practiced in the art including barcodes (e.g., UPC, EAN, PDF417, etc.), photosymbols, standard or specialized text, etc., or any future type of symbology. Of course, as stated, any symbology utilized will represent or lead to the file names and file locations of the digital images.

The device 100 will further include an integrated scanning module 130 that will contain a light source, e.g., LED, and photocell coupled to the computer processing module 120, or alternatively, will includes a separate decoder engine that will decode the data received by the photocell before sending it to the computer processing module 120. Knowledge of the art reveals that many different types of scanners currently exist and the inventor realizes that the type of scanner would depend upon the type of symbology that is utilized in the printed images. The user will be able to scan the printed digital images with the device 100 and the scanning module 130 would scan in the symbology. Using standard computer programming and the computer processing module, the device would translate the symbology to extract the name of the digital image and the file locations (whether local or on the Global Computer Network) of the digital image. Alternatively, the scanner may extract some type of marker or symbol, e.g., an identifier, that when presented to the relational database would indicate the file name and file location of the digital images. This information would then be transferred to the transmission module which will transmit it to the local or Global Computer Network which will then submit it to the relational database containing information on the digital images. Using standard computer programming and processing, this database would then locate the stored digital image and associated files/information and also process the users request(s) regarding the digital image.

If the subject hardware device is coupled to a computer via the transmission module 112, then the hardware device 100 will receive back and display the processed requests on the display module 108. By example, a user may scan in a printed digital image with the hardware device 100 and then receive that image for display on his device, along with auxiliary information on the image, and along with auxiliary and associated audio and video files that can be displayed on the hardware device via the display module 108.

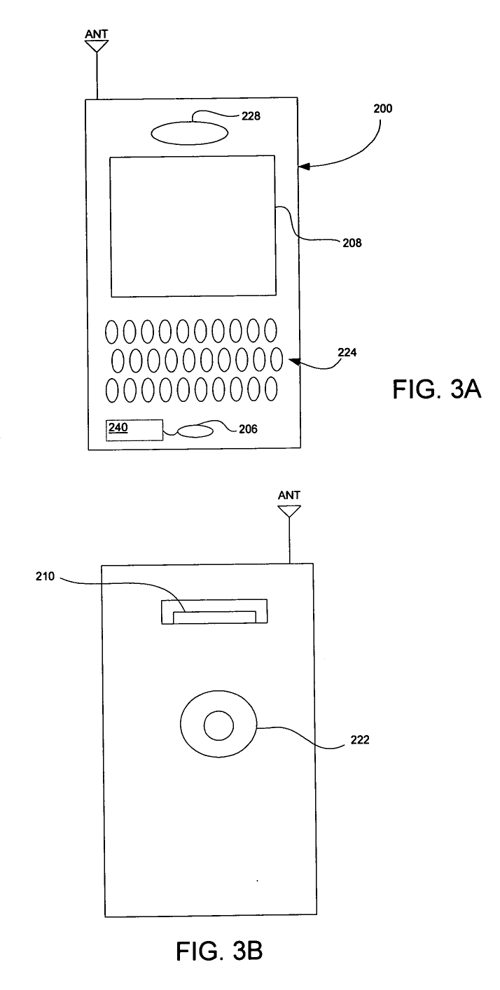

Referring to FIGS. 3A and 3B, another embodiment of the present disclosure is illustrated. Here, a device 200 according to the principles of the present disclosure is embodied as a mobile phone including the modules and architecture illustrated in FIG. 2. Device 200 includes a microphone 206 having the same functionality as microphone 106 and is further coupled to a communication module 240 for encoding a user's speech to be transmitted via antenna ANT using CDMA, PCS, GSM or any other known wireless communication technology. Device 200 further includes display module 208 for displaying captured images and preferably the display module will have a touch screen overlaid upon it which will enable user input via a stylus. The user may also enter phone numbers to be dialed via the touch screen. As is known in the mobile phone art, device 200 may include a full QWERTY keyboard 224 as an input module to enter text information to be associated to captured images. Earpiece or speaker 228 may be utilized to play audio clips associated with images in addition to being coupled to the antenna ANT and a decoder for receiving and decoding voice communication from another mobile phone.

Preferably, the antenna ANT is coupled to a transmission module similar to the one described above in relation to FIG. 2. The transmission module will compress and encode captured images for transmission using any known wireless communication technology. Transmitting images via wireless technology will facilitate the transferring of images to an online photo storage site or to an online photo developing service provider.

Referring to FIG. 3B, a rear side of device 200 is shown. Capture module 222 is employed for capturing images and when disposed on a rear side of device 200 is used in conjunction with display module 208 for positioning a subject of the image in lieu of a viewfinder. In this embodiment, the capture module 222 may also be used in conjunction with the scanning module to read symbology associated with an image. Here, the capture module will acquire an image of the symbology and the scanning module will further include a digital signal processor executing an algorithm for deciphering or decoding the symbology from the capture image. The use of an image sensor to read symbology, e.g., a barcode, is known in the art and systems employing such technology is commercially available from Symbol Technologies of New York.

Similar to the embodiments described in relation to FIGS. 1 and 2, device 200 includes a storage module 210 for storing images via a removable memory card.

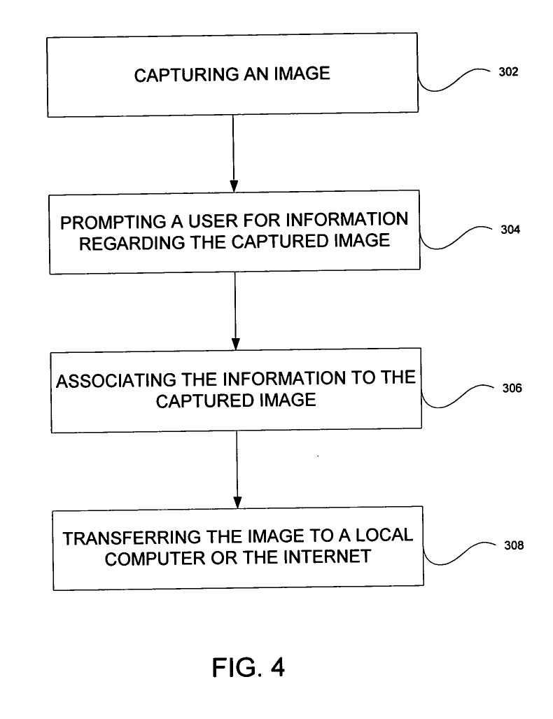

In utilizing the hardware device(s) described herein, the user will be able to accomplish the various applications of the disclosure which are described below in relation to FIG. 4.

A user takes several pictures with his imaging device (step 302). In one example, the picture is of a baby in Las Vegas. The next picture is of a Monet painting hanging in a gallery in Las Vegas. Another picture is of the user's wife. At end of taking pictures or, alternatively, immediately after taking each individual picture, the user goes back to the device 100, 200 and using either keystroke input via input module 124 or voice recognition software via a microphone, or any other input means, the user enters information regarding the pictures. The user may be prompted, e.g., either via the display module or by spoken word via the speaker, to provide the following information regarding the pictures, i.e., the images taken (step 304):

(1) The file location to store the photos or images once they are transferred to permanent memory storage, e.g., a local computer or a server residing on the Internet. For the first picture the user indicates that he would like the photo stored under his baby picture file, e.g., a folder on his local computer, for the second picture his famous art file, and for third picture his file with pictures of his wife.

(2) The user is then asked via the speaker, or prompted on the display module 108, 208, if he wants to attach any audio or video to the images to stay associated with the images once they are stored. He indicates that for the first image he wishes to record an audio file indicating: “This is a picture of my baby girl Samantha here in Las Vegas. Boy is she cute”; for the second image: “Loved this Monet and had previously seen it in at the Louvre last year”; and for the third image: “Jenny is wearing the new dress that I just bought her”; also for number three picture please attach the video file entitled Jenny's day in Las Vegas to this picture.

(3) The user now is asked to enter, via text input or voice recognition or any other input means, whether they will be storing these photos online. The answer would be either Yes or No. If the user answers Yes, a predetermined site could have been selected and pre-stored in the camera hardware device (for instance, the Ofoto or Imagestation site) and selected photos would automatically go to that location for upload when the digital images are transferred.

The hardware device retrieves (from input that it receives from the auxiliary input computer module 126) the time and location of the images. The hardware device also knows (from memory that was pre-stored in the hardware) the name and identification information on the owner of the hardware device or any guest using the device. Moreover, the hardware device will also store the number of the digital image by recording the order that the image was taken in, e.g., the sequence number. The user can also flag (i.e., select) any images that he would like to have printed or e-mailed.

The various information is then complied and either stored as a separate information file associated to the image or appended to the digital image file and stored for example in the header of the image file (step 306).

The user will now transfer the images to his local computer workstation which may or may not be connected to the Global Computer Network via transmission module 112 (step 308). When the computer receives these imbedded ‘smart pix’ images, the computer will:
a. Sort and file the images in the file or folder selected including storing the files with the associated information and audio and video attachments;
b. Perform any actions requested for the photos including, e-mail the photos to a selected user or users and print the photos on designated printers in a size pre-selected; and
c. With a connection to the Global Computer Network, automatically upload the photos and associated attached files to the specified server site (Ofoto, or Smartpix, for instance) for storage and retrieval.

Once the images are printed, the user will be enabled, regardless of the time elapsed since the images were taken, to take a hardware device (possibly the camera device that the user utilized to take the images, or another hardware reader device) and scan it over a photo. The device will read the symbology in the images and using standard communications techniques including Wi-Fi, Bluetooth, infrared, cabling, etc., the scanning/reading device will transmit the photo identifier information to a computer processor which then may optionally transfer it to the Global Computer Network. The device will then receive the information back from the local processor or Global Computer Network and will then locate the file or files that contain the image and associated attachments on the local or Global Computer Network.

By example, the user holds the scanning device over images of a child on the beach and an audio track then comes back: “Daddy I love this beach and I love you”. The user would also be able to instantly receive information on the photo such as when and where the photo was taken and who the photographer was. The user could also request that the photo be printed to a local printer in a specific size or that the picture be e-mailed to a selected recipient. Other user requests could include asking the local computer to display all associated photos, file attachments, or to store the photo in a selected location on the local computer or the Global Computer Network.

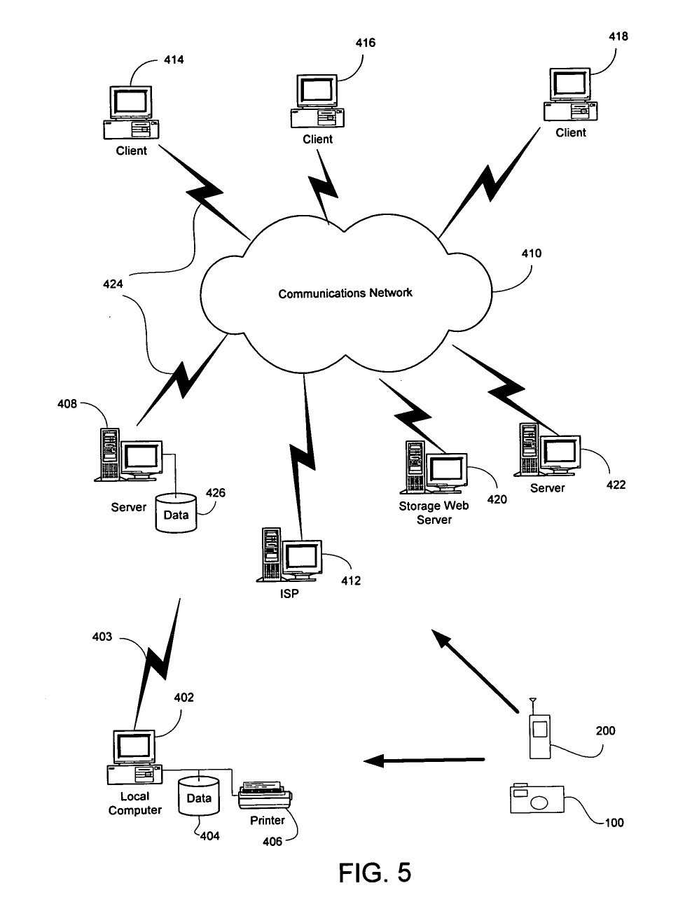

Referring to FIG. 5, an exemplary system for managing a plurality of digital images in accordance with an embodiment of the present disclosure is illustrated. Digital imaging device 100, 200 will transfer the digital images to a user's local computer 402 or to an online imaging web server 408, e.g., Ofoto, where the plurality of images will be processed and manipulated as will be described below. The user's local computer 402 may connect via a communications device to communications network 410, e.g., the Internet, by any known means, for example, a hardwired or wireless connection 403. It is to be appreciated that the network 410 may be a local area network (LAN), wide area network (WAN), the Internet or any known network that couples a plurality of computers to enable various modes of communication via network messages. It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by, local computer 402 or web server 408. The local computer 402 and web server 408 will include an operating system and micro instruction code. The various processes and functions described herein may either be part of the micro instruction code or part of the application program (or a combination thereof) which is executed via the operating system. In addition, various other peripheral devices may be connected to the computer platform, e.g., the local computer 402 and web server 408, by various interfaces and bus structures, such as a parallel port, serial port or universal serial bus (USB), for example, additional storage devices 404, 426, a printer 406 and a communication device for communicating to the device 100 and other computing devices on the network.

Alternatively, the user's local computer 402 may connect to the network 410 via an Internet Service Provider (ISP) 412, where once connected, the ISP server 412 will manage the flow of the digital images, e.g., e-mailing the images to other users 414, 416, 418 of the network 410, transmitting the images to online storage web servers 420, and/or manage the flow of information from various web sites connected to the network 410, e.g., content providers residing on servers 422. Furthermore, the ISP 412 will include a mail server for handling electronic mail, e.g., e-mail. The mail server will include the appropriate applications and/or servers for handling incoming mail, e.g., Simple Mail Transfer Protocol (SMTP), and outgoing mail, e.g., Post Office Protocol 3 (POP3).

Although the physical environment in FIG. 5 shows the connected devices as computers, such illustration is merely exemplary and may comprise various digital devices, such as PDAs, network appliances, notebook computers, etc. The computing devices may communicate to the servers 408, 412, 420, 422 and network 410 via any known communication link 424, for example, dial-up, hardwired, cable, DSL, satellite, cellular, PCS, wireless transmission (e.g., 802.11a/b/g), etc. Furthermore, the devices will communicate using the various known protocols such as Transmission Control Protocol/Internet Protocol (TCP/IP), File Transfer Protocol (FTP), Hypertext Transfer Protocol (HTTP), etc.

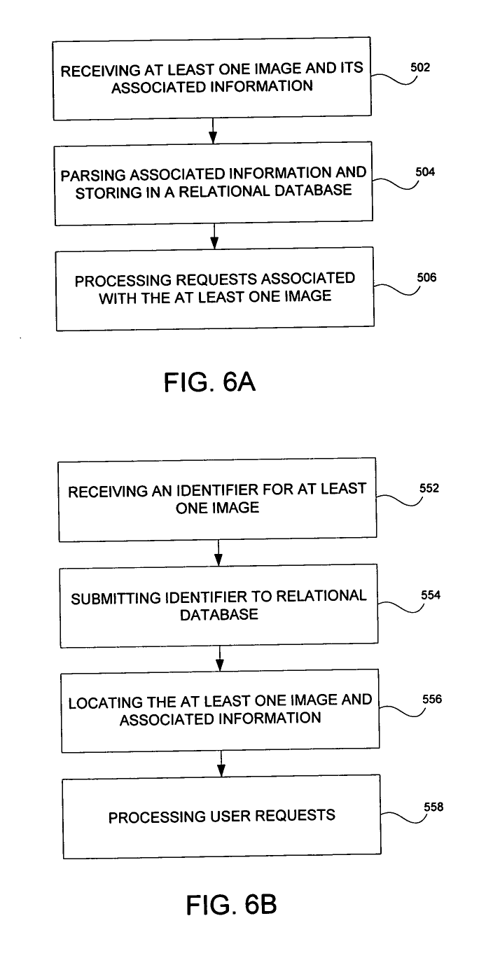

FIGS. 6A and 6B are flowcharts illustrating methods being executed by programmable instructions either at the local computer 402 or the imaging web server 408. Although the following description will be described in relationship to methods being implemented by software on the local computer 402, the methods can be implemented at web server 408 after the images are transferred to the web server 408 via the Internet.

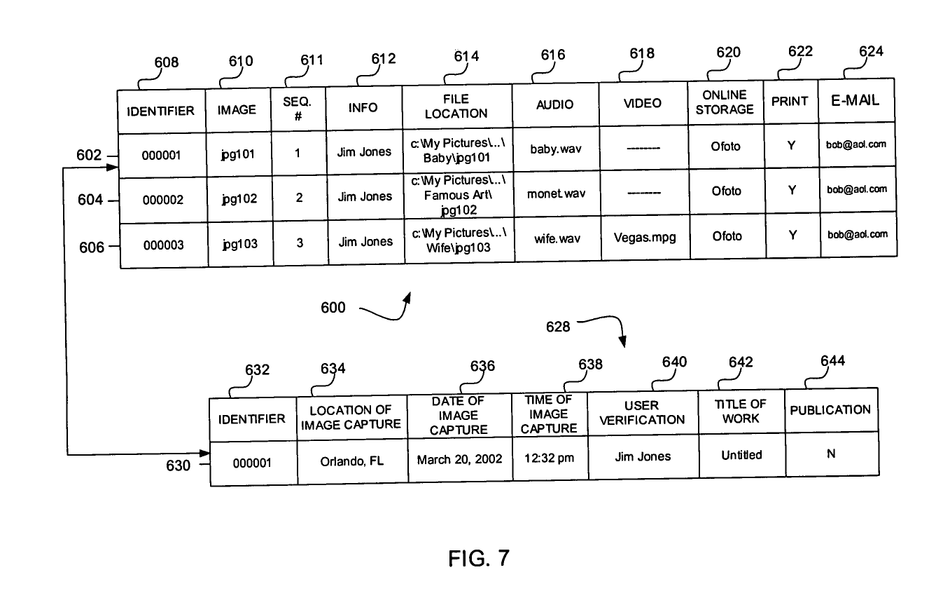

Referring to FIG. 6A, once information is associated to at least one digital image, the image and associated information is transferred from device 100, 200 and received by local computer 402 (step 502). The local computer 402 will parse the associated information and store each piece of data as a separate field in a single record in a relational database (step 504). An exemplary database 600 is shown in FIG. 7. The database 600 includes a record 602, 604, 606 for each image and further includes a plurality of fields for each record. For example, record 602 includes an identifier field 608 for storing any alphanumeric identifier associated with the digital image, an image field 610 including the file name of the image, a sequence number field 611 for storing an image sequence number, an info field 612 which may include user information, subject information, image description, date, time, etc., and a file location field 614 for storing the location where the image file is stored. Record 602 also includes an audio field 616 for storing the file name of an associated audio file and a video field 618 for storing the file name of an associated video file. Record 602 further includes request fields, e.g., online storage request field 620, print request field 622 and e-mail request field 624, which will cause the local computer to process and take further action with regard to the image transferred, which will be described in more detail below.

Next, in step 506, the local computer 402 will use relational database programming, e.g., Structured Query Language (SLQ), and standard computer processing power to respond to any user requests for each of the digital images. These requests include but are not limited to displaying the digital images in a particular sequence, or sorting the digital images by owner, date, location, description, etc. The local computer 402 will query each record of the relational database to determine if an action has been requested. For example, the local computer will query e-mail request field 624 to determine if the image is to be e-mailed to another. As shown in FIG. 7, e-mailing the digital images to a person has been indicated by the user, with such person's e-mail address being stored in the relational database, e.g., bob@aol.com. As another example, the local computer 402 will query print request field 622 to determine if the user has flagged the image to be printed upon transfer. The record may include further information regarding printing the image such as a printer location (either local or on the Global Computer Network) and in a size or format that has been requested by the user. As an even further example, the local computer 402 may query online storage request field 620 to determine if the user wants to store the image on a public server for viewing purposes. The field 620 may include the name or location of a professional photo processing location on the Internet, such as ImageStation or Ofoto. Although not shown, each record may include other request fields, for example, fields for requesting the display of information on any selected digital image, such information being contained in the relational database, or the display of related audio or video or image files. The inventor understands and current computer database and computer processing techniques teach, that various other requests to the computer processor regarding the digital images and associated files/information may be made by the user, and by using standard programming and computer processing power these requests will be completed by the computer and presented to the user.

The user, or any other party, may print out any of the digital images. The printing will be done once the images are stored on the local computer 402 or a web server 408 on the Global Computer Network and recorded in the relational database 600 as described above. When the images are printed out, the computer that prints the image will cause the image to be printed with symbology that encodes the file name of the image and file location of the image. This file name will be the assigned name that the image was stored in at the relational database, as well as the assigned location of the relational database whether in the user's local computer or at a stored location on the Global Computer Network. Alternatively, the symbology will represent a unique identifier that is created for each image as stored in field 608 of each record in the database. The symbology may be in any form currently practiced in the art including barcodes, photosymbols, standard or specialized text, etc, or any future type of symbology. Of course, any symbology utilized will represent the file names and file locations of the digital images either directly or via an identifier.

At any time, a user may now scan the printed digital images. This scanning may be done by any type of scanner that could read the symbology contained in the printed digital images. Many different types of scanners that read symbology currently exist and the inventor realizes that the type of scanner would depend upon the type of symbology that is utilized in the printed images. Preferably, the scanning of a printed digital image will be performed by the hardware devices 100, 200 described above including the appropriate scanning module.

The device 100, 200 would scan in the symbology and using standard computer programming and computer processing, translate the symbology to extract the name of the digital image and the file locations (whether local or on the Global Computer Network) of the digital image, or alternatively, the identifier of the record relating to the image. This information is then transmitted to the user's local computer along with a user request. In another embodiment, this information would be submitted to the location of the computer indicated in the symbology and, at that location, this query would be submitted to the relational database containing information on the digital images.

The local computer 402 will receive the file name and location or image identifier for at least one image in step 552. Using standard computer programming and processing, the identifier will be submitted to the database (step 554) and the database would then locate the stored digital image and associated files and/or information via its corresponding record (step 556). Once the record is found, the computer will process any user request(s) regarding the digital image that was either transferred with the identifier or after the identifier located the appropriate record (step 558). Such requests could include but would not be limited to displaying the digital images in a particular sequence at the local computer or on the imaging device 100, 200; e-mailing the digital image to a person that has been indicated by the user, with such person's e-mail address being stored in the relational database; and printing the digital images at a printer location (either local or on the global computer network) and in a size or format that has been requested by the user. Furthermore, a request may include a request for displaying information on any selected digital image, such information being contained in the relational database, for example, displaying audio or video or image files that are related to the selected digital image. Depending on the request, the image and associated information may be displayed or presented to the user at the local computer 402 or the image and associated information may be transmitted to the imaging device 100, 200 for presentation to the user.

By example, the user holds a scanning device, e.g., imaging device 100, mobile phone 200, etc., over an image of a child on the beach processed via the system and method of the present disclosure. An audio track then comes back: “Daddy I love this beach and I love you” audibly produced via speaker 128, 228 on the device 100, 200 respectively, or alternatively, the image and audio track are presented to the user if they are at the local computer 402. The user would also be able to instantly receive information on the photo such as when and where the photo was taken and who the photographer was. The user could also request that the photo be printed to a local printer in a specific size or that the picture be e-mailed to a selected recipient. These further requests could be entered either via a keyboard/mouse at the local computer 402 or via input module/speech recognition at the device 100, 200. Other user requests could include requesting the computer to display all associated photos, file attachments, or to store the photo in a selected location on the local computer or the Global Computer Network.

It is to be appreciated that the software utilized to implement the above methods could reside at server 408 with relational database 600 residing in storage medium 426. Here, the user may employ local computer 402 to transfer the digital images and requests to server 408. In this embodiment, a user could access any of the plurality of images and associated information from any location in the world having access to the Internet. Furthermore, the use of a mobile communication device such as device 200 described above would facilitate the transferring of images and requests to the server 408 by way of a wireless connection either directly to the server 408 or via ISP 412 to the server 408.

The principles of the present disclosure will allow users numerous applications for these imbedded “smart pix” including retrieving image and information from third parties, e.g., a publisher or clearing house. By way of example, a user could see an image in a newspaper or magazine and the user could scan the photo with the hardware device described above. The user could then order the photograph to be downloaded to the user's local computer; request and receive information from the publisher of the image; request and receive other information on the image including attachments; e-mail the photo to someone else; and/or direct the photo to be printed for pickup at a local computer printer or at a commercial printer location.

In a further embodiment of the present disclosure, the device 100, 200 is employed to automatically copyright captured digital images and will be used in conjunction with the system of FIG. 5 to apply for a copyright registration in a particular jurisdiction's applicable copyright office, e.g., the United States Copyright Office.

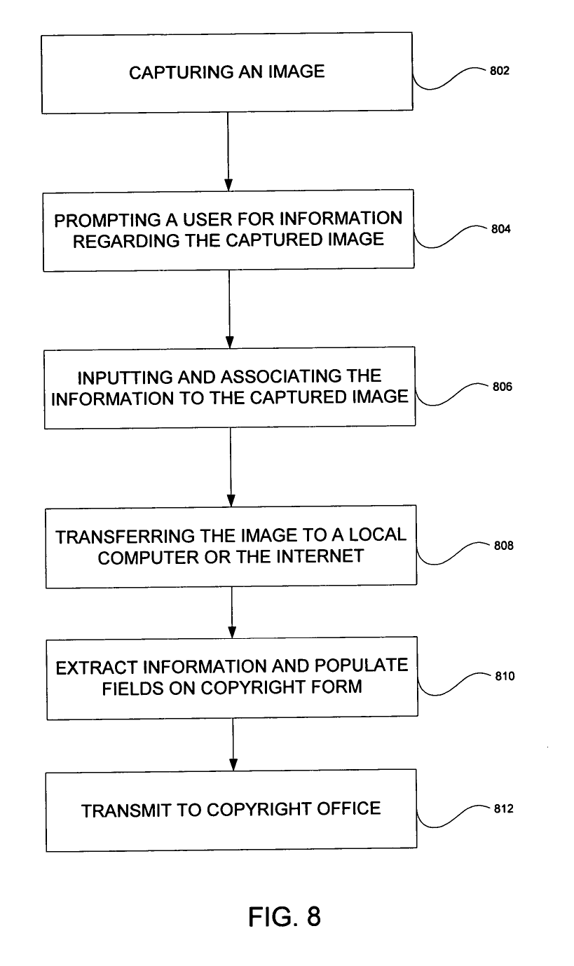

Referring to FIG. 8, a user will capture a digital image as described above (step 802). It is to be appreciated that the digital images may be created with any digital image capture device which may take the form of traditional cameras, personal digital assistants, telephones, or any other device which captures and stores digital images which now exists or will exist in the future and the method described below may be implemented on and/or with any such device. For the purposes of this illustrative embodiment, the device 100 described above will be referred to in describing the method of the present disclosure. Once the image is captured, the image will be stored in a digital file format in the storage module 110.

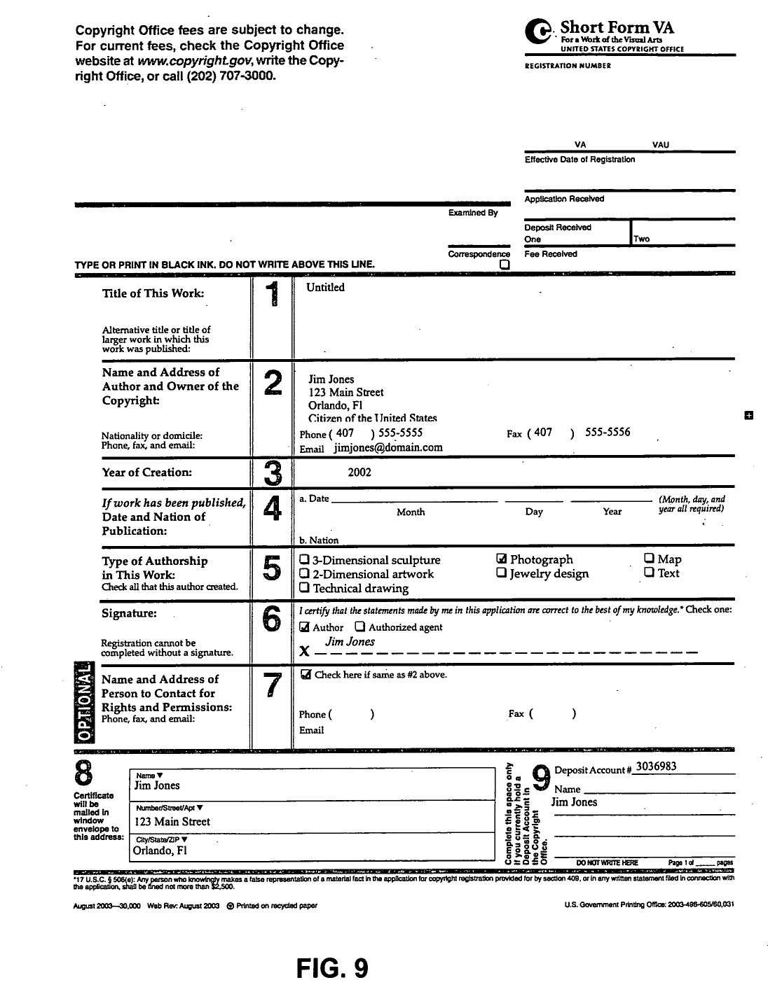

Once the image is captured, the device 100 will prompt the user for information regarding the captured image (step 804). The device 100 will be programmed to ask the user, if requested upon device initialization, several questions that will be asked immediately after each image is captured, or alternatively, after a series of digital images have been captured but before the hardware device is powered off. One of the questions is if the user wishes to automatically copyright a particular digital image. The questions will be presented to the user via the display module 108 or will be spoken to the user via the audio output device 128. The user will use the user input module 124 to answer this question for an individual image. In the case of the user being asked the question after a series of digital images have been captured, the hardware device 100 will be programmed to display the images on a display module 108, and the user will use the user input module 124 to answer the question for each previously captured image. If the user answers “Yes” for any individual image, then the hardware device 100 will be programmed to further ask the user a series of questions that is required for the copyright registration for the image. These questions will vary depending on the country that the user is registering the image with and the type of form being used. For example, in the case of the United States Copyright Office, current applicable questions would be taken from a form to register a “Work of the Visual Arts”, that is, Form VA or Short Form VA (see FIG. 9). For example, if the device is programmed according to Short Form VA, the user would be prompt with the following questions:

1. What if any is the title of this work?

2. Name and Address of Author and Owner of the Copyright, including nationality or domicile, phone, fax and email

3. Year of creation

4. If the image is going to published, the date and nation of publication

5. What is the type of authorship; and

6. Name and address of person to contact for rights and permissions.

Alternatively, if the device is programmed according to the Form VA, the user would be prompted with the following questions, among others:

1. What if any is the title of this work?

2. Name of Author, including nationality or domicile, and dates of birth and death; Is this image a work made for hire? Yes or No; What is the type of authorship?

3. Year of creation

4. If the image is going to published, the date and nation of publication

5. Name and address of person to contact for rights and permissions.

6. Is there a previous registration for this work

7. Is this work a “changed version”, “compilation” or “derivative work”.

The questions listed above are only for illustration proposes and it is to be understood that more or less questions may be presented and/or entirely different questions may be presented depending on the jurisdiction the user intends to file for copyright protection.

It is to be appreciated that the questions may be programmed directly into device 100, or alternatively, may be programmed at the user's local computer 402 and transferred to the device via transmission module 112. In a further embodiment, computer 402 will periodically access a web site of the applicable copyright office, e.g., residing on server 422, to determine if an updated form is available. If it is determined that an updated form is available, the local computer 402 will download the form and, using conventional character recognition software, will determine the new questions and will download these new questions to the device 100.

As the questions are presented, the user will answer each question presented and other answers may be derived from the auxiliary input module 126 as will be described below (step 806). Depending on the type of question, the user may answer the question via text input or voice recognition. For example, if the device prompts the user for a title for the work, the user may enter a title with a character recognition capture device, e.g., a stylus via the touch screen, or through a standard keyboard interface. Alternatively, if the question only requires a “Yes” or “No” answer, the user may simply speak their response which will be captured by microphone 106 and translated into digital text via voice recognition technology as described above. It is to be appreciated that regardless of the question presented, the user may enter all the information requested by manual text input or by voice recognition.

As described above, the device 100 will also contain an auxiliary input module 126. This module will allow the hardware device to automatically and simultaneously (with image capture), store information in the storage module 110. The information from the auxiliary input module 126 will flow directly from the various input processors contained in the hardware device. Upon device initialization, the user will have stored in these processing modules (using the user input module 124) information relative to copyright registration required by the user's relevant copyright office. This information will include the users identity, the users date of birth, the users nationality, the assignee for any work for hire, the name of the publication for any works for hire, and any other information relative to the copyright registration requirements of the user's jurisdiction. The various processors in the hardware device 100 will also provide additional information to the auxiliary input module 126 including the date the image was captured, and the file name of the image. All of the information will be transferred to the storage module 110.

It is to be appreciated that depending on the jurisdiction of the applicable copyright office and registration form being used, the information required for the copyright registration will come from user input and the auxiliary input module 126. In some situations, minimal input will be required by the user. For example, if the user desires to file a copyright registration in the US Copyright Office using Short Form VA, the user will be prompted to enter a title for the work, i.e., the captured image. All other information required by the form will come from the auxiliary input module, e.g., name and address of author including nationality or domicile, year of creation, type of authorship (here, photograph) and name and address of copyright owner.

Once the requested information is either inputted by the user or extracted from the auxiliary input module, the information is associated to the captured image either as a separate file or appended to the digital image file as described above (step 806). By example, if the digital image is recorded by the hardware device as jpg101 or tif101 or bmp101 where these descriptions indicate the name of the captured digital image, then another file will be created for each captured digital image. This file would be the information associated file. In the above example, the image jpg101 would now have an additional file called info101 (or any other name that the hardware device selects). This digital file would receive and contain the user inputted information and/or the information transmitted by the auxiliary input module 126. Alternatively, the device may write this information directly to the previously stored digital image file. By example, if the digital image is recorded by the hardware device as jpg101 or tif101 or bmp101 where these descriptions indicate the name of the captured digital image, then this file will be appended with the additional information written from the user input module and auxiliary input module, for example, in the header of the digital image file.

After the digital image is captured and stored on the hardware device along with the associated information, the digital image file will be transferred to the user's local computer hardware device 402 or to the Global Computer Network, or to the user's local device 402 and then to the Global Computer Network (step 808). This transfer will be done by the standard digital file transfer means via the transmission module 112 including but not limited to hard wire cabling, USB connectivity, Infrared connectivity, Firewire (1394 connectivity) cabling, Bluetooth connectivity, removable flash memory cards, WiFi connectivity, or any future transmission means.

The file name of each digital image file or associated file as well as the digital image itself, will be recorded in a relational database either on the user's local computer or on a computer on the Global Computer Network. This database will contain information on any file(s) related to each digital image including audio and video files, or other associated image files. The information in the associated file or embedded directly into the digital image file will be extracted or parsed from the associated file or from the digital image file and placed in an appropriate field of the image record 602, 604, 606 in the relational database shown in FIG. 7. Referring to FIG. 7, the information captured and associated will either be incorporated to table 600 or stored as a separate table 628 which is linked to table 600 via the use of private and foreign keys as is known in the art. Tables 600, 628 will include all the information relevant for completing the copyright registration form or application. For example, record 630 will include an identifier field 632 which will also be used as a key for linking the tables, a location of image capture field 634, a date of image capture field 636, a time of image capture field 638, a user verification field 640, a title of work field 642 and a publication field 644. It is to be appreciated that any record may include more fields as necessary to complete a particular form being employed.

The relational database will contain the forms that are necessary for the country that the user wishes to register the digital image copyright with. Alternatively, the relational database may contain forms supplied by an agent for the applicable copyright office. In either case, the information contained in the database received from the device 100 and supplemented with additional user supplied information (such as payment information) will allow these forms to be filled out by standard computer processing power, e.g., by executing a script (step 810).

Once the form is completed, the form may be transmitted to the applicable copyright office (step 812). Depending on the jurisdiction, the form for copyright registration may require additional information or documentation to complete the application for copyright registration, for example, a deposit of the work (e.g., a predetermined number of copies of the image), a filing fee, etc. In most cases, the filing fee may be paid by check, credit card, electronic fund transfer, etc. and, in certain jurisdictions, the user may establish a deposit account, in which the user can charge copyright fees against the balance in their account instead of sending a separate remittance with each registration application. In a preferred embodiment, the user's credit card information or deposit account number will be stored in the relational database so that information may be entered into the form and the user will not have to manually write a check to be sent with the application.

In one embodiment, the transmitting of the copyright registration application will be performed via conventional postal mail. In this embodiment, the user's local computer 402 will execute the program to populate the required form and print out the completed application along with the required deposit materials, e.g., two copies of the image if the image is going to be published. It is to be appreciated that the form will include the information for the payment of the filing fee. Additionally, the user's local computer 402 may print out a return receipt request to be filed with the application which will be returned to the user upon receipt by the copyright office. The printed registration form and required deposit material may then be simply placed in an envelope and mailed to the appropriate copyright office.

In another embodiment, the transmission of the copyright registration application will be conducting electronically over the Global Computer Network, e.g., the Internet. In this embodiment, the user's local computer 402 will complete the copyright registration application as described above, including payment information, e.g., either a credit card number, deposit account number, etc. The completed application will be transmitted along with the required deposit materials to the server of the applicable copyright office. This transmission may be performed by any known communication process or protocol, e.g., via email, HTTP, FTP, etc. Once the copyright registration application has been received by the applicable copyright office, a confirmation receipt will be transmitted back to the user, e.g., via e-mail. Furthermore, once the copyright registration process has been completed, the copyright office (depending on the country) may use the Global Computer Network to notify and send proof of registration, e.g., a copyright certificate, electronically to the user.

An illustration of the system and method for applying for copyright protection will be described in relation to FIGS. 5, 7, 8 and 9.

A user takes several pictures with device 100 (step 802). In this non-limiting example, the photographer is a commercial photographer who is photographing objects for future publication. The user then flags certain digital images for automatic copyright registration via input module 124. It is to be appreciated that the user may flag individual images for copyright as each image is captured, flag particular images after a series of images are captured or place the device in copyright mode were each image is flagged during a session. The user is then prompted for information relating to the captured images via the display module 108. The user enters into the device, either by text input or by voice recognition, certain information pertaining to the individual image(s) that he wishes to register, such information being required by the individual copyright office that the user is registering the image at (step 806). The user then transfers the images that have been captured to a local computer 402 or directly to a server 408 on the Global Computer Network 410 (step 808).

The computer (whether local or a computer on the Global Computer Network) will then place these images in a relational database and using software programming and computer processing power the database will read the digital files containing the image(s) or the file(s) associated with the images to also place information from these file(s) into the records 602, 604, 606, 630 of the relational database.

The database will then use standard programming and computer processing power to complete the forms required by the applicable copyright office (step 810). An exemplary form is shown in FIG. 9 entitled “Short Form VA”, which may be used to apply for copyright registration in the United States Copyright Office. Referring to FIG. 9, the fields of the form are automatically populated with the information in the records of the relational database. For example, field 1 of Short Form VA is completed with information from field 642 of record 630. Field 2 of Short Form VA is completed with information from field 612 of record 602. Although not shown, info field 612 will include the address and other personal information of the user. Furthermore, field 3 of Short Form VA is completed with information from field 636 of record 630. Other fields of the form are completed in a similar fashion. It is to be appreciated some fields may be automatically completed such as field 5 of Short Form VA which indicates that the work being submitted is a photograph. Furthermore, field 9 of Short Form VA will indicate that the user will charge the filing fee for the registration against their previously established deposit account.

Once the copyright registration form is completed, the local computer or computer residing on the Internet will electronically transfer the form and any required samples of the digital image(s) to the copyright office or to a server of the copyright office using the Global Computer Network (step 812). The copyright office will then (depending on the particular copyright office) electronically transfer back to the user a receipt or confirmation that all the required application parts have been received. At a later time, the user will also receive proof, e.g., a copyright registration certificate, that the digital image(s) have been registered with the copyright office.

All of these procedures will be automated so that by simply requesting a copyright registration at the time of image capture, the selected digital image(s) can be automatically copyrighted.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for applying for copyright registration for at least one digital image, the method comprising the steps:
receiving at least one digital image file along with information associated to the at least one digital image;
parsing the associated information and storing each piece of parsed information in at least one field of a record of a database;
populating at least one field of a copyright registration form with information extracted from the database; and
transmitting the copyright registration form to a copyright office of a particular jurisdiction.

2. The method as in claim 1, wherein the associated information is a separate information file that is linked to the digital image file.

3. The method as in claim 1, wherein the associated information is appended within the digital image file.

4. The method as in claim 1, wherein the associated information includes at least one of a title of the at least one digital image, name and address of author of the at least one digital image, year of creation of the at least one digital image, the date and nation of publication of the at least one digital image and type of authorship.

5. The method as in claim 1, further comprising the step transmitting the at least one digital image file to the copyright office.

6. The method as in claim 1, further comprising the step periodically retrieving an updated copyright registration form.

7. The method as in claim 1, wherein the transmitting step includes:
printing the populated copyright registration form and a predetermined number of copies of the least one digital image; and
mailing the populated copyright registration form and the predetermined number of copies of the least one digital image to the copyright office.

8. The method as in claim 1, wherein transmitting step includes electronically transmitting the populated copyright registration form and a predetermined number of copies of the least one digital image over a network to the copyright office.

9. The method as in claim 1, further comprising the step receiving a confirmation that the copyright registration form has been received at the copyright office.

10. A system for applying for copyright registration for at least one digital image, the system comprising:
a digital imaging capture device comprising:
a capture module configured to capture at least one digital image;
a processing module configured to associate information to the at least one digital image; and
a transmission module configured to transmit the at least one digital image and the associated information to a computing device; and
the computing device comprising:
a communication device configured to receive at least one digital image file and associated information; and
a processor configured to parse the associated information and store each piece of parsed information in at least one field of a record of a database, populate at least one field of a copyright registration form with information extracted from the database, and transmit the copyright registration form to a copyright office of a particular jurisdiction through the communication device.

11. The system as in claim 10, wherein the associated information includes at least one of a title of the at least one digital image, name and address of author of the at least one digital image, year of creation of the at least one digital image, the date and nation of publication of the at least one digital image and type of authorship.

12. The system as in claim 11, wherein the digital imaging capture device further comprises a display module for prompting a user with at least one question to input the associated information regarding the at least one digital image.

13. The system as in claim 12, wherein the computing device is configured to transmit the at least one question to the digital imaging capture device.

14. The system as in claim 12, wherein the computing device is configured to retrieve an updated copyright registration form, determine the at least one question from the updated form and transmit the at least one question to the digital imaging capture device.

15. The system as in claim 11, wherein the digital imaging capture device further comprising an auxiliary input module configured for generating at least one of the associated information.

16. The system as in claim 10, further comprising a printing device configured for printing the populated copyright registration form and a predetermined number of copies of the least one digital image.

17. The system as in claim 10, wherein the processor of the computing device is further configured for electronically transmitting the populated copyright registration form and a predetermined number of copies of the least one digital image over a network to a server of the copyright office.

18. The system as in claim 10, wherein the associated information is a separate information file that is linked to the digital image file.

19. The system as in claim 10, wherein the associated information is appended within the digital image file.

20. A program storage device readable by a machine, tangibly embodying a program of instructions executable by the machine to perform method steps for applying for copyright registration for at least one digital image, the method steps comprising:
receiving at least one digital image file along with information associated to the at least one digital image;
parsing the associated information and storing each piece of parsed information in at least one field of a record of a database;
populating at least one field of a copyright registration form with information extracted from the database; and
transmitting the copyright registration form to a copyright office of a particular jurisdiction.
